(19) United States
(12) Patent Application Publication
(10) Pub. No.: US 2014/0002902 A1
(43) Pub. Date: Jan. 2, 2014

(54) Manufacturing a Plurality of Optical Elements

(71) Applicant: Hartmut Rudmann, Jona (CH)

(72) Inventor: Hartmut Rudmann, Jona (CH)

(73) Assignee: HEPTAGON MICRO OPTICS PTE. LTD., Singapore (SG)

(21) Appl. No.: 13/981,844

(22) PCT Filed: Jan. 23, 2012
(86) PCT No.: PCT/CH2012/000015

§ 371 Date: Sep. 23, 2013

Related U.S. Application Data
(60) Provisional application No. 61/435,855, filed on Jan. 25, 2011.

(51) Int. Cl. G02B 7/02

(52) U.S. Cl. CPC G02B 7/02
USPC 359/503; 264/1.7

(57) ABSTRACT

A method for manufacturing a plurality of optical devices comprising the steps of:—Providing a replication tool (1), the replication tool comprising a replication surface defining an array of replication cells, each replication cell comprising a lens replication portion (2) and a spacer replication portion (3), wherein the spacer replication portion on the replication tool is more indented than the lens replication portion,—Bringing the replication tool and a support (6) in contact with each other with replication material (11) between the replication surface and the support,—Causing the replication material to harden,—Wherein the lens replication sections are caused to be kept at a distance from the support when the support rests against the replication tool,—Removing the replication tool, and—Separating the hardened replication material into individual optical devices, each device having a replicated surface portion with a structure corresponding to a negative of a replication cell and comprising a spacer portion and a lens portion, wherein the lens portion is recessed with respect to the spacer portion.

### FIELD OF THE INVENTION

The invention is in the field of optical elements and methods of manufacturing optical elements and integrated devices with one or more optical elements, e.g. refractive and/or diffractive lenses, on wafer scale by means of a replication process.

### BACKGROUND OF THE INVENTION

Integrated optical devices are, for example, camera devices, optics for camera devices, or collimating optics for flash lights, especially for camera mobile phones. Manufacture of optical elements by replication techniques, such as embossing or molding, is known. Of special interest for a cost effective mass production are wafer-scale manufacturing processes where an array of optical elements, e.g. lenses, is fabricated on a disk-like structure (wafer) by means of replication. In some cases, two or more wafers with optical elements attached thereto are stacked in order to form a wafer scale package or wafer stack where optical elements attached to different substrates are aligned.

Subsequent to replication, the wafer or wafer scale stack can be separated into individual optical devices (dicing).

A wafer or substrate in the meaning used in this text is a disc or a rectangular plate or a plate of any other shape of any dimensionally stable, often transparent material. The diameter of a wafer disk is typically between 5 cm and 40 cm, for example between 10 cm and 31 cm. Often it is cylindrical with a diameter of either 2, 4, 6, 8, 10 or 12 inches, one inch being about 2.54 cm. The wafer thickness is for example between 0.2 mm and 10 mm, typically between 0.4 mm and 6 mm.

Integrated optical devices include functional elements, at least one of which is an optical element, stacked together along the general direction of light propagation. Thus, light travelling through the device passes through the multiple elements sequentially. These functional elements are arranged in a predetermined spatial relationship with respect to one another (integrated device) such that further alignment with each other is not needed, leaving only the optical device as such to be aligned with other systems.

Such integrated optical devices can be manufactured by stacking wafers that comprise functional, e.g. optical, elements in a well defined spatial arrangement on the wafer. Such a wafer scale package (wafer stack) comprises at least two wafers that are stacked along the axis corresponding to the direction of the smallest wafer dimension (axial direction) and attached to one another. At least one of the wafers bears replicated optical elements, and the other can comprise or can be intended to receive optical elements or other functional elements, such as electro-optical elements (e.g. CCD or CMOS sensor arrays). The wafer stack thus comprises a plurality of generally identical integrated optical devices arranged side by side.

WO 2009/076 786 discloses methods of manufacturing a wafer-scale spacer that is used for stacking the different wafers on top of each other. The method essentially comprises casting a wafer with an array of through holes using a curable material. This spacer wafer is then placed in contact with the two wafers to be stacked, with the holes roughly aligned with the optical or other functional elements.

This method has proven to be efficient. However, the manufacturing optical devices with a spacer still entails several steps.

### SUMMARY OF THE INVENTION

It is an object of the present invention to provide a method of manufacturing a plurality of optical devices, an optical device and an integrated optical device that overcome drawbacks of prior art methods and devices and that are especially economical.

In accordance with an aspect of the present invention, a method for manufacturing a plurality of optical devices provided, the method comprising the steps of:
Providing a replication tool, the replication tool comprising a replication surface defining an array of replication cells, each replication cell comprising a lens replication portion and a spacer replication portion, wherein the spacer replication portion on the replication tool is more indented than the lens replication portion,

Bringing the replication tool and a support in contact with each other with replication material between the replication surface and the support,
Causing the replication material to harden,
Wherein the lens replication sections are caused to be kept at a distance from the support while the replication material hardens,
Removing the replication tool, and
Separating the hardened replication material into individual optical devices, each device having a replicated surface portion with a structure corresponding to a negative of a replication cell and comprising a spacer portion and a lens portion, wherein the lens portion is recessed with respect to the spacer portion.

The spacer portion then has an abutment surface with respect to which the replicated lens portion is recessed and that may be affixed to a for example essentially plane surface of a further device so that a cavity arises between the plane surface and the lens portion. The abutment surface may be flat and parallel to the wafer plane (i.e. the x-y-plane in which during manufacturing the array extends). In many embodiments, the spacer portion surrounds the recessed lens portion so that the optical device, together with the plane surface against which it abuts, forms a hollow space that may be hermetically sealed, for example by an adhesive layer between the plane surface and the spacer.

By this method, an optical device that comprises a lens and integrated the often necessary spacer is formed by a single replication step.

In this text, the terms “light” and “optical” do not only refer to visible electromagnetic radiation but also, if appropriate to near and middle infrared electromagnetic radiation and, where appropriate, to soft UV radiation.

An ‘array’ in this text is a plurality of for example identical elements that are arranged in a pre-defined pattern. In most cases, two-dimensional arrays are preferred over 1D-arrays. In many embodiments, an array typically has at least 64, in most cases considerably more optical elements.

In many embodiments the replication tool and the support rest against each other while the replication material hardens. To this end, the replication tool and the support together define a stop structure that causes the lens replication sections to be kept at a distance from the support (with replication material between the lens replication sections and the support) while replication tool and the support rest against each other and the replication material hardens. For example, such stop structures may be protrusions of the replication tool (or alternatively of the support). There need not be a stop structure in every replication cell. Rather, one or more wafer-scale peripheral or evenly distributed stop structure(s) may be sufficient.

The step of causing the replication material to harden may for example by an UV irradiation step if the replication material is UV curable epoxy.

Prior to the step of separating the hardened replication material into individual optical devices there may optionally be further assembly steps, such as wafer-scale stacking of wafer-scale optical and/or optoelectronic devices. The step of separating may then be made for the wafer-scale assembly together.

The method may comprise the further step of assembling the optical device with a further optical device or with an optoelectronic device, the further step comprising the sub-steps of bringing the spacer portion in contact with an assembly surface of the further optical device or optoelectronic device and of attaching it thereto. These sub-steps can be made prior to the step of separating the wafer-scale array into the individual devices or after separating. If the spacer surrounds the recessed lens portion, then a hollow, potentially hermetically sealed space may be generated by the assembling step.

After the step of causing the replication material to harden, the support may be removed. In embodiments, the support may comprise a rigid plate and, in contact with the replication material, a for example sacrificial mold release layer, for example a plastic foil.

Alternatively, at least a part of the support may remain attached to the hardened replication material and constitute a part of the array of optical elements manufactured. In these situations, the support (or part thereof) is generally transparent and in many embodiments has some rigidity to add dimensional stability. For example, the support or a layer thereof in contact with the replication material may be of glass.

In addition to the lens portion being a replicated structure in the replication material on the replication tool side (and spacer side), a further replicated lens structure may be added to the support side. To this end, the support—for example a sacrificial layer thereof—may have a structured surface that replicates said further structure into the replication material simultaneously with the lens portion and the spacer portion on the replication tool side. The support is then aligned with the replication tool prior to the hardening step. As an alternative, a separate replication tool may be used to add replicated structures on the support side after the removal of the support, or, if the support or parts thereof remain, on the back side of the support. In this, a further amount of replication material may be used for replicating the further structure into; the further amount may be of the same or of a different replication material.

The invention also concerns an integrated optical device that comprises an optical device of the hereinbefore described kind with a lens portion recessed relative to the spacer portion, especially a spacer portion that surrounds the lens portion, wherein the spacer portion is integrally formed, in one piece with the lens portion. In addition, the integrated optical device comprises a further optical device or an electrooptical device attached to the abutment surface of the spacer. The spacer in this defines the distance between the lens portion of the optical device and the further optical or electrooptical device. The further optical or electrooptical device may have a partially flat upper surface to which the spacer portion's abutment surface may be attached. Especially, in the integrated optical device, the recess in which the lens portion is replicated may form a hollow space hermetically sealed by the spacer portion being attached to the further optical device.

### BRIEF DESCRIPTION OF THE DRAWINGS

Principles of the invention as well as embodiments thereof will be explained in more detail in the following text with reference to the attached drawings. In the drawings, same reference numerals denote same or analogous elements. The drawings are all schematic and not to scale. They show:

FIGS. 1a-1d Manufacturing a wafer-scale spacer by a method according to the prior art;

FIGS. 2a-2c Manufacturing a wafer-scale optical device comprising an array of optical devices on a wafer scale by an embodiment of the method according to the invention;

FIG. 3 A view of example of a wafer-scale optical device;

FIG. 4 An alternative wafer-scale optical device;

FIGS. 5-12 embodiments of single optical devices; and

FIGS. 13 and 14 embodiments of integrated optical devices.

### DESCRIPTION OF THE PREFERRED EMBODIMENTS

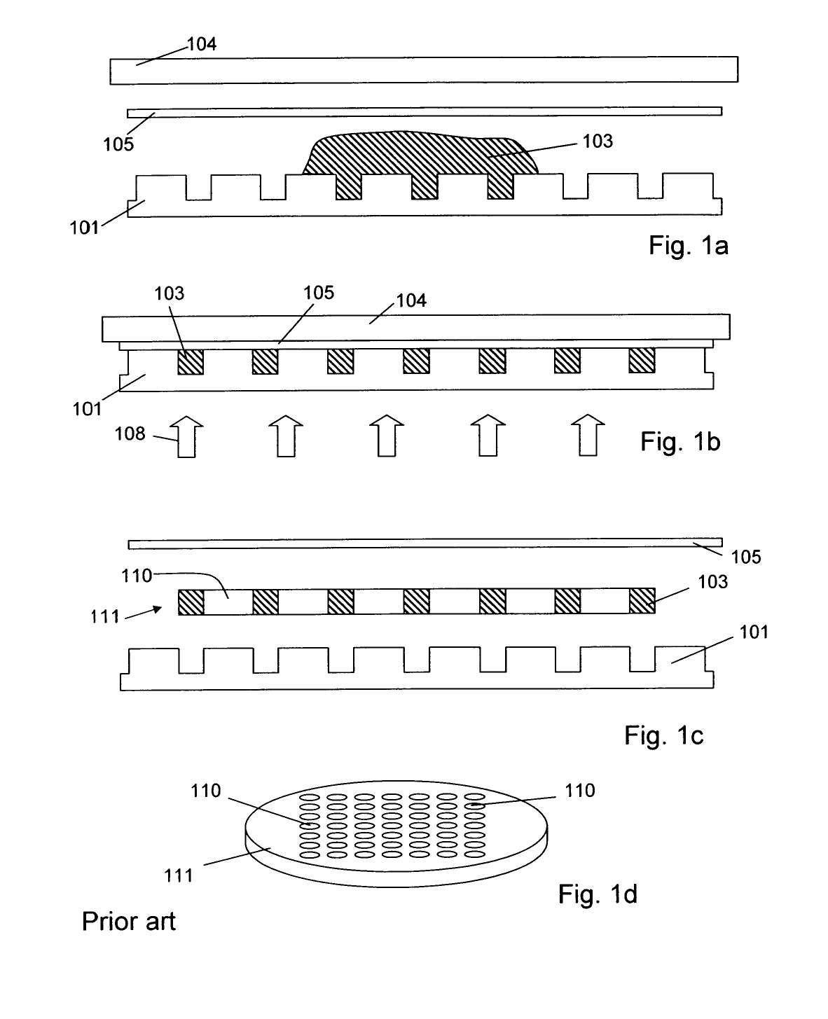

A process for manufacturing a wafer-scale spacer of the kind taught in WO 2009/076 786 is illustrated FIGS. 1a-1d. A spacer replication tool 101 of for example PDMS on a glass plate is used as a spacer replication tool. The replication tool may itself have been, prior to the manufacturing of the spacer, replicated from a spacer master.

A hardenable material such as a curable material 103 (for example transparent or non-transparent UV curable epoxy) is poured over the replication tool. The amount of dispensed material corresponds to the amount needed to constitute the spacer volume. Then a glass plate 104 with a sacrificial mold support 105 (for example foil of a suitable plastics, such as Polyethylenterephthalat, for example Mylar) is placed on top of the replication tool to press the curable material 103 into the spacer replication portions of the replication tool. During the replication process (FIG. 1b), the glass plate with release support is pressed against the tool so that at the places where the spacer has to have openings 110 the plate/support assembly abuts directly against the correspondingly protruding features of the replication tool. During the replication process, UV radiation 108 is used to cure the spacer material.

Because the glass plate support abuts against the protruding features of the replication tool, after removal of the glass plate and the release support 105, the openings 110 of the spacer 111 are through openings. In subsequent steps of manufacturing integrated optical elements, the spacer 111 is for example stacked on an optical wafer with replicated lenses at places that correspond to the through openings 110. FIG. 1d depicts a smaller scale view of the spacer in which the through openings for the replicated lenses (or other elements) are visible.

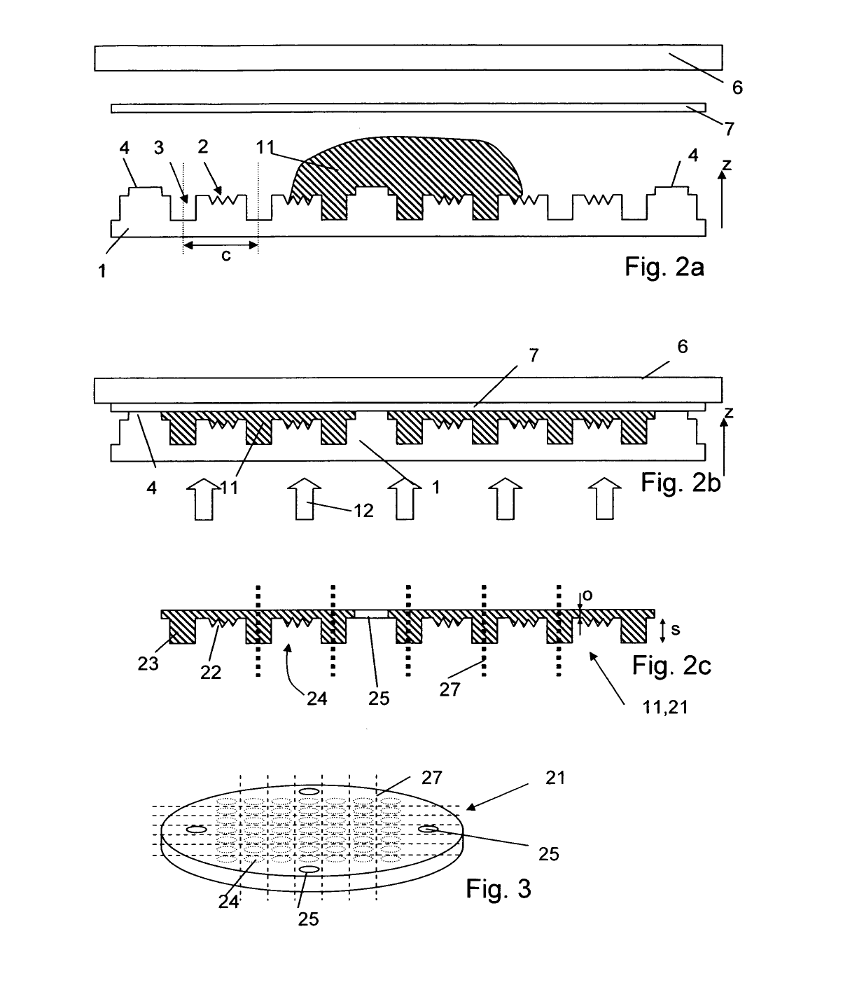

An embodiment of the method according to the invention is shown in FIGS. 2a-2c. The replication tool 1 has a fore side or replication side. In the depicted embodiment, the back side is essentially flat. For example, the replication tool may comprise a rigid back plate and, attached thereto on the fore side, a replication portion for example of a material with a remaining elasticity, such as PDMS.

The replication tool itself may have been manufactured by replication from a master that comprises the structure of the spacer as well as the lens structures.

The fore side of the replication tool defines an array of replication cells (with a cell extension c). The replication cells define a lens replication section 2 and a spacer replication section 3. In the depicted configuration, the spacer replication section surrounds the lens replication section. The spacer replication section 3 is constituted by an indented section of the replication tool. The lens replication section 2 has features that correspond to the negative of a refractive and/or diffractive lens. The schematically drawn structure of the lens replication section 2 in the depicted configuration is intended to symbolize a diffractive lens; however the teaching of the invention and embodiments thereof equally well applies to refractive and combined refractive/diffractive lenses. The spacer replication section 3 of each cell is generally deeper than the deepest feature of the lens replication section 2, i.e. z-extension of the replication tool on the fore side is less at the spacer replication portions than at the lens replication portions.

FIG. 2a also depicts a support comprising, in the shown embodiment, two parts. A first part is a plate 6, for example a glass plate. A second part is a sacrificial mold release support 7 that may again be a foil of the hereinbefore described kind.

The replication tool further comprises stop structures 4 that protrude more than a most prominent feature (the feature protruding the most into the z direction) of the lens replication portion so that the most prominent features of the lens replication portions 2 are held at a distance from the support when the support rests against the replication tool. The stop structures do not need to be present in each cell but can for example be peripheral on the wafer-scale tool and/or can be distributed over the tool in a space saving manner.

A transparent replication material 11 that is capable of being brought from a liquid or plastically deformable state into a solid state is for example poured on the replication tool 1. The replication material may for example be a UV curable transparent epoxy. As an alternative to pouring over the tool, the material may also be dispensed in a plurality of portions distributed over the tool and/or on the support or on both, the support and the tool.

FIG. 2b depicts the situation during replication. The replication tool and the support 6, 7 rest against each other while the replication material 11 is between the replication tool and the support. The stop structures 4 serve for defining the relative z position of the tool and the support and for keeping the support at a distance from the lens replication sections. UV radiation 12 impinges to harden the UV curable material. The UV radiation can be incident from the tool side (as depicted; the tool then has to be transparent for this radiation), or from the support side or both.

The resulting wafer-scale optical device 21 is shown in FIG. 2c. The wafer-scale optical device 21 is a replica of the replication side of the replication tool and thus comprises a spacer 23 (that may be contiguous over the whole wafer-scale optical device or be segmented into cell-scale or multi-cell segments) and per cell a lens portion 22. The spacer has a portion in each cell, i.e. each cell comprises a spacer portion so that after separating along separation lines 27 each individual optical device has a spacer portion. The spacer portion is generally flat on the bottom side so that the bottom side (in the depicted orientation) may serve as abutment surface and may rest against a flat surface of a further device with which the optical device is to be assembled. The lens portion 22 is recessed in relation to the spacer portion (referring to the lower side in FIG. 2c), and according the recess 24 may be completely surrounded by the spacer portion 23 so that when the device rests against a flat surface, the recess forms a hollow space. At places where during replication the stop structures 4 were located, a through hole 25 may be seen. This depends on the arrangement of the stop structures. In alternative embodiments, the stop structure may for example be ring-shaped and peripherally surrounding the wafer-scale optical device 21 in which case it is not visible in the wafer-scale optical device.

A view of an example of a wafer-scale optical device 21 is shown in FIG. 3. The recesses 24 are in the lower surface, whereas the upper surface in the shown embodiment is flat. FIG. 3 shows a—often advantageous—configuration where the spacer is contiguous over the whole wafer-scale optical device, and the separation lines 27 go through the spacer. Typical z-extension s (see FIG. 2c) of the spacer portions of wafer-scale optical devices 21 (i.e. the quantity by which spacer protrudes above the lens portions 22) are between 100 and 1500 Micrometers, whereas the thickness o of the lens portions is typically between 50 Micrometers and 600 Micrometers, for example between 70 and 400 Micrometers. The features of the optical device form an array (or a grid in the depicted embodiment) repeating for example every 1 mm to 10 mm, especially every 2 mm to 5 mm. This pertains to different kinds of embodiments, the invention, however, not being restricted to particular dimensions.

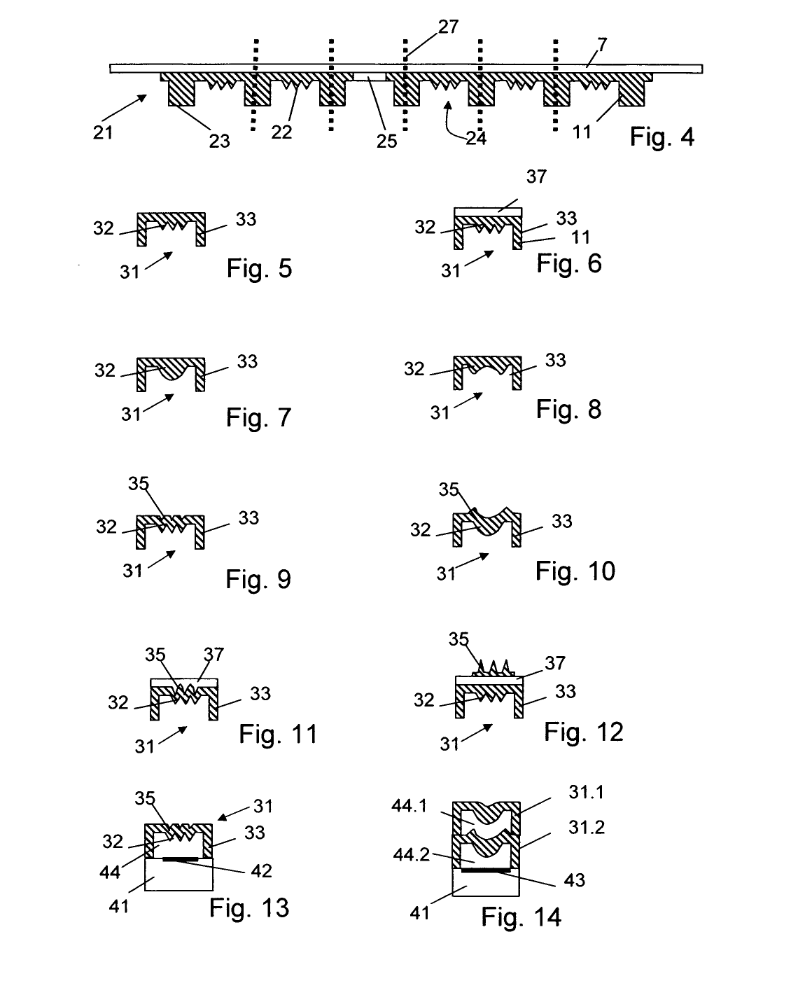

In an alternative embodiment, schematically illustrated in FIG. 4, the support does not comprise a sacrificial (i.e. meant to be removed after replication and disposed of) mold release support but the support or a portion thereof is intended to be part of the optical device and to remain attached to the replicated material 11 after the hardening thereof. In such embodiments, the support 7 or the portion thereof in contact with the replication material 11 may for example be made of glass. This embodiment may be advantageous in situations where the additional mechanical stability and/or protection provided by the support 7 is desired.

Separation along the separation lines 27 may for example be achieved by dicing with a dicing saw, by laser cutting, punching, water jet cutting or any other suitable separation method.

FIGS. 5-12 show, in section, embodiments of individual optical devices 31 after separation. Each device comprises a lens portion 32 that is a replica of a lens replication section of the replication tool. The lens portion 32 is recessed in relation to the spacer portion 33.

The embodiments of FIGS. 6 and 12 in addition comprise a support 37 of a material different from the replication material. Such embodiments are manufactured by separating a wafer-scale optical device of the kind depicted in FIG. 4 into individual pieces, i.e. the support is a piece of the wafer-scale support 7.

The embodiments of FIGS. 5 and 6 are schematically illustrated to be diffractive lenses, whereas the embodiments of FIGS. 7 and 8 are refractive lenses.

In embodiments, the also support can be structured to replicate a further lens structure 35 into the side of the optical element that faces away from the spacer portion 33 (the ‘back’ side). Then, the support has to be placed relative to the replication tool in aligned manner. To this end, the support and the replication tool may have according alignment marks. FIGS. 9, 11 and 12 show according examples of diffractive structures, whereas FIGS. 10 depicts a refractive further lens structure 35. The embodiments of FIGS. 11 and 12 are special in that they combine further lens structures with a support remaining in contact with the replication material. In the embodiment of FIG. 11, the further lens structure is provided at the interface between the replication material and the support. Its effect depends on the difference between the indices of refraction of the replication material and the support. In the embodiment of FIG. 12, the further lens structure is provided at the back side of the support. It requires dispensing a separate amount of replication material between the support and a further replication tool (not shown) that is to be aligned with the replication tool 1. Dispensing in this further replication tool may for example be achieved in individual portions as for example described in WO 2007/107027 and in WO 2007/107025.

Of course, the principles sketched in FIGS. 11 and 12, apply—like all other principles discussed in this text—to all, diffractive, refractive and combined diffractive/refractive lenses.

Combinations of a further lens portion on the fore side of the support as shown in FIG. 11 and a further lens portion on the back side of the support as shown in FIG. 12 are also possible.

FIGS. 13 and 14 yet show integrated optical devices with optical devices of the hereinbefore described kind.

FIG. 13 schematically depicts an LED light source (which can be a flashlight or intended for continuous illumination). An optical device of the described kind being a diffractive lens with a spacer portion 33 is directly mounted on the LED chip 44 with the optically active (light producing) surface 42 facing to the optical device. The spacer portion 33 both, positions the diffractive lens relative to the light source and hermetically seals the hollow space 44 in front of the chip so that the optical device also provides protection from environmental influences. The optical device 31 may for example be glued to the chip 41.

The chip 41 and the optical device 31 may be assembled individually, i.e. an optical device obtained by separating a wafer-scale optical device 21 into the individual devices may be attached to an individual chip. Alternatively, it is also possible to assemble on a wafer scale. To this end a wafer with an array of optically active surfaces may be attached, in an aligned manner, to a wafer-scale optical device. The resulting assembly is then together divided into individual integrated optical devices.

As yet other alternatives, it would also be possible to attach a plurality of chips to the wafer-scale optical device and to then separate the latter or to attach a plurality of individual optical devices to a wafer with the optically active surfaces and then to dice the wafer.

FIG. 14 shows a fix focus camera that comprises a plurality of refractive lenses stacked on each other. Both lenses are formed by optical devices 31.1, 31.2 in accordance with embodiments of the invention. The chip 41 has an optically active surface 43, for example a CMOS sensor surface. The optical devices 31.1, 31.2 together with the chip define two hermetically sealed hollow spaces 44.1, 44.2. Between the abutment surface of the first optical device's 31.1 spacer and the second optical device 31.2, and/or between the abutment surface of the second optical device's spacer 31.2 and the chip 41, there may be layers of a (same or different) adhesive.

Manufacturing of the camera assembly of FIG. 14 may be done by manufacturing the optical devices 31.1, 31.2 and the chip 41 individually and then attaching these components to each other. In many situations, however, a wafer-scale assembly at least of the two optical devices is preferred. To this end, two wafer-scale optical devices 21 with arrays of the first and the second refractive lenses, respectively are stacked on each other and affixed, for example glued, to each other. Then the resulting component is divided into individual multi-lens devices, each having the optical devices 31.1, 31.2, the multi-lens devices are then assembled with the chips 41. As an even further alternative, also assembly with a wafer comprising the chips 41 in an array is possible. Finally, also combined wafer-scale/individual assembly steps as described hereinbefore for the LED are also possible.

Many other embodiments are possible without departing from the scope and spirit of the invention.

1. A method for manufacturing a plurality of optical devices, the method comprising the steps of:
providing a replication tool, the replication tool comprising a replication surface defining an array of replication cells, each replication cell comprising a lens replication portion and a spacer replication portion, wherein the spacer replication portion on the replication tool is more indented than the lens replication portion;
bringing the replication tool and a support in contact with each other with replication material between the replication surface and the support;
causing the replication material to harden, wherein, during the step of causing the replication material to harden, the lens replication sections are caused to be kept at a distance from the support;
removing the replication tool; and
separating the hardened replication material into individual optical devices, each device having a replicated surface portion with a structure corresponding to a negative of a replication cell and comprising a spacer portion and a lens portion, wherein the lens portion is recessed with respect to the spacer portion.

2. The method according to claim 1, wherein the spacer portions have a flat abutment surface facing to a same side as the lens portion.

3. The method according to claim 1, wherein the spacer portions surround the recessed lens portions.

4. The method according to claim 1, wherein the replication tool and the support rest against each other during the step of causing the replication material to harden.

5. The method according to claim 4, wherein the replication tool and the support define a stop structure that causes the lens replication sections to be kept at a distance from the support.

6. The method according to claim 1 comprising removing the support prior to the step of separating.

7. The method according to claim 6, wherein the support comprises a plate and a sacrificial layer, and wherein the step of removing the support prior to the step of separating comprises removing the plate and the sacrificial layer.

8. The method according to claim 1 wherein after the step of causing the replication material to harden and during the step of separating, the support or a portion thereof adheres to the hardened replication material.

9. The method according to claim 1, wherein the support comprises a support replication structure being a negative of a further lens structure to be replicated, and wherein during the step of causing the replication material to harden, the support replication structure faces towards the replication tool and is in contact with the replication material.

10. The method according to claim 1 comprising the further step of adding, prior to the step of separating, further replication material and replicating a structure into said further replication material.

11. The method according to claim 10, wherein the step of adding is effected after the step of causing the replication material to harden.

12. The method according to claim 10, wherein after the step of causing the replication material to harden, the support or a portion thereof adheres to the hardened replication material, and wherein in the step of adding, the further replication material is brought in contact with a side of the support or portion thereof that faces away from the replication material.

13. An optical device comprising a replicated lens portion recessed relative to a spacer portion that surrounds the lens portion, wherein the spacer portion is integrally formed, in one piece with the lens portion and comprises an abutment surface suitable for being attached to a further optical or electrooptical device to generate a hollow space between the lens portion and the further optical or electrooptical device, the hollow space being hermetically sealed off from the surroundings by the optical device, the further optical or electrooptical device, and a layer of adhesive between the abutment surface and the further optical or electrooptical device.

14. An integrated optical device comprising:
an optical device with a replicated lens portion recessed relative to a spacer portion that surrounds the lens portion, wherein the spacer portion is integrally formed, in one piece with the lens portion and comprises an abutment surface; and
a further optical or electrooptical device, wherein the abutment surface of the spacer portion is attached to the further optical or electrooptical device to generate a hollow space between the lens portion and the further optical or electrooptical device, the hollow space being hermetically sealed off from the surroundings.
